(19) United States
(12) Patent Application Publication
(10) Pub. No.: US 2008/0109273 A1
(43) Pub. Date: May 8, 2008

(54) System and method for predicting a displayable form of a term

(75) Inventors: Kevin Bartz, Cambridge, MA (US); Cory Barr, Burbank, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/592,615

(22) Filed: Nov. 3, 2006

(51) Int. Cl. G06Q 10/00; G06Q 30/00

(52) U.S. Cl. 705/7; 705/14

(57) ABSTRACT

Systems and methods for predicting a displayable form of a term is disclosed. Generally, a displayable form suggestion tool receives a term. The displayable form suggestion tool canonicalizes the term and applies a displayable form model based on search logs of an online advertisement service provider to the received term to determine a set of potential displayable forms of the term. The set of potential displayable forms of the term are suggested to an editor and the editor selects one of the suggested displayable forms of the term. The displayable form suggestion tool may then export the selected displayable form of the term to a system of the online advertisement service provider such as an advertisement campaign management system for insertion into a digital ad such as a graphical banner ad or a sponsored search listing.

### BACKGROUND

The present invention relates generally to online advertising systems. More particularly, the present invention relates to online advertising systems in which advertisers bid competitively on placement of advertisements for viewing by online searchers.

On example of such an online system is disclosed in U.S. Pat. No. 6,269,361, assigned to Overture Services, Inc. This patent discloses a system and method in which online advertisers may influence the position of their search listings in search results provided to a searcher. The advertisers submit search listings having bid amounts and search terms. The advertisers may submit any number of search terms to the online system.

Advertisers who advertise with online advertisement service providers such as Yahoo! Search Marketing often bid on large numbers of terms in a form that is not suitable for insertion into typical digital advertisements such as graphical banner ads or sponsored search listings. For example, advertisers may bid on the terms “wedding bands celtic,” “loony tune,” “airfare cost low,” and “lawn tractor cover.” However, it will be appreciated that if these terms are inserted directly into a title or the text of an advertisement, the advertisement would not be grammatically correct.

Online advertisement service providers often employ editors who manually review and edit terms in advertisements so that a term like “wedding band celtic” may be appear in advertisement titles or the text of an advertisement as “Looking for Celtic wedding bands?” or a term like “loony tune” may appear in advertisement titles or the text of an advertisement as “Looking for Loony Tunes products?” During manual review of terms, editors continually rephrase and edit the casing of millions of terms for insertion into advertisements. That is, the editors select upper and lower case letters for the advertisements, as appropriate, based on context and other factors. Further, editors are often required to rephrase and edit the casing of the exact same term for insertion into advertisements many times.

To reduce the amount of manual review by editors, it would be desirable to provide a system and method for predicting a displayable form of a term and a system and method for predicting a correct casing variation of a term.

### BRIEF DESCRIPTION OF THE DRAWINGS

FIG. 1 is a block diagram of one embodiment of an environment in which a system for predicting a displayable form of a term and a system for predicting a correct casing variation of a term may operate;

FIG. 2 is a block diagram of one embodiment of a system for predicting a displayable form of a term;

FIG. 3 is a flow chart of one embodiment of a method for predicting a displayable form of a term;

FIG. 4 is a block diagram of one embodiment of a system for predicting a correct casing variation of a term; and

FIG. 5 is a flow chart of one embodiment of a method for predicting a correct casing variation of a term.

### DETAILED DESCRIPTION OF THE DRAWINGS

The present disclosure is directed to a system and method for predicting a displayable form of a term. As explained in more detail below, a displayable form of a term is a variation of the term that may be inserted into an advertisement such as a graphical banner ad or a sponsored search listings such that the ad is grammatically correct after the term is inserted. The disclosed system provides an efficient tool to assist editors in rephrasing terms for systems in an online advertisement service provider such as rephrasing terms into the displayable form of the term for insertion into digital advertisements.

The present disclosure is additionally directed to a system and method for predicting a correct casing variation of a term. As explained in more detail below, a correct casing variation of a term is a variation of a term where all letters of each word in the term are properly capitalized and all necessary symbols have been inserted into the term. The disclosed system provides an efficient tool to assists editors in choosing a casing variation of a term for systems in an online advertisement service provider such as choosing a casing variation of a term for insertion into digital advertisements.

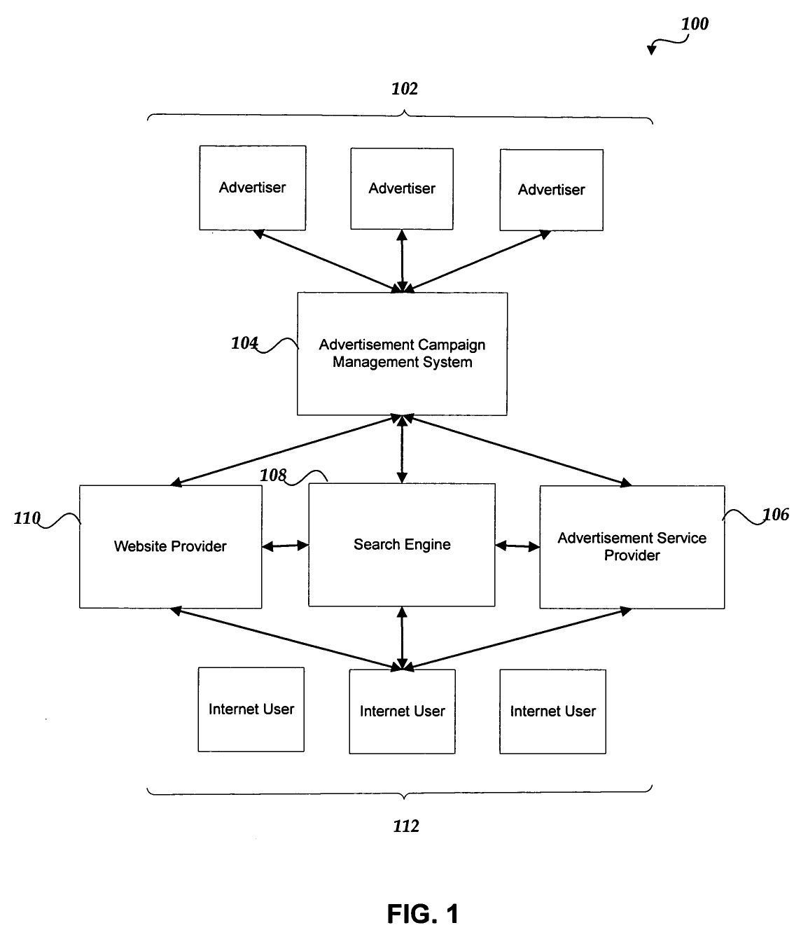

FIG. 1 is a block diagram of one embodiment of an environment in which a system for predicting a displayable form of a term and a system for predicting a correct casing variation of a term may operate. The environment 100 includes a plurality of advertisers 102, an advertisement campaign management system 104, an advertisement service provider 106, a search engine 108, a website provider 110, and a plurality of Internet users 112. Generally, an advertiser 102 bids on terms and creates one or more advertisements by interacting with the advertisement campaign management system 104 in communication with the ad provider 106. The advertisement may be a banner advertisement that appears on a website viewed by Internet users 112, an advertisement that is served to an Internet user 108 in response to a search performed at a search engine, or any other type of online marketing media known in the art.

When an Internet user 112 performs a search at a search engine 108, or views a website served by the website provider 110, the advertisement service provider 106 serves one or more advertisements created using the advertisement campaign management system 104 to the Internet user 112 based on search terms or bidded phrases (also known as keywords) provided by the internet user or obtained from a website. Additionally, the advertisement campaign management system 104 and advertisement service provider 106 typically record and process information associated with the served advertisement. For example, the advertisement campaign management system 104 and advertisement service provider 106 may record the search terms that caused the advertisement service provider 106 to serve the advertisement; whether the Internet user 112 clicked on a URL associated with the served advertisement; what additional advertisements the advertisement service provider 106 served with the advertisement; a rank or position of an advertisement when the Internet user 112 clicked on an advertisement; or whether an Internet user 112 clicked on a URL associated with a different advertisement. One example of an advertisement campaign management system the may perform these types of actions is disclosed in U.S. patent application Ser. No. 11/413,514, filed Apr. 28, 2006. It will be appreciated that the systems and methods disclosed below for predicting a displayable form of a term and predicting a correct casing of a term may operate in the environment of FIG. 1.

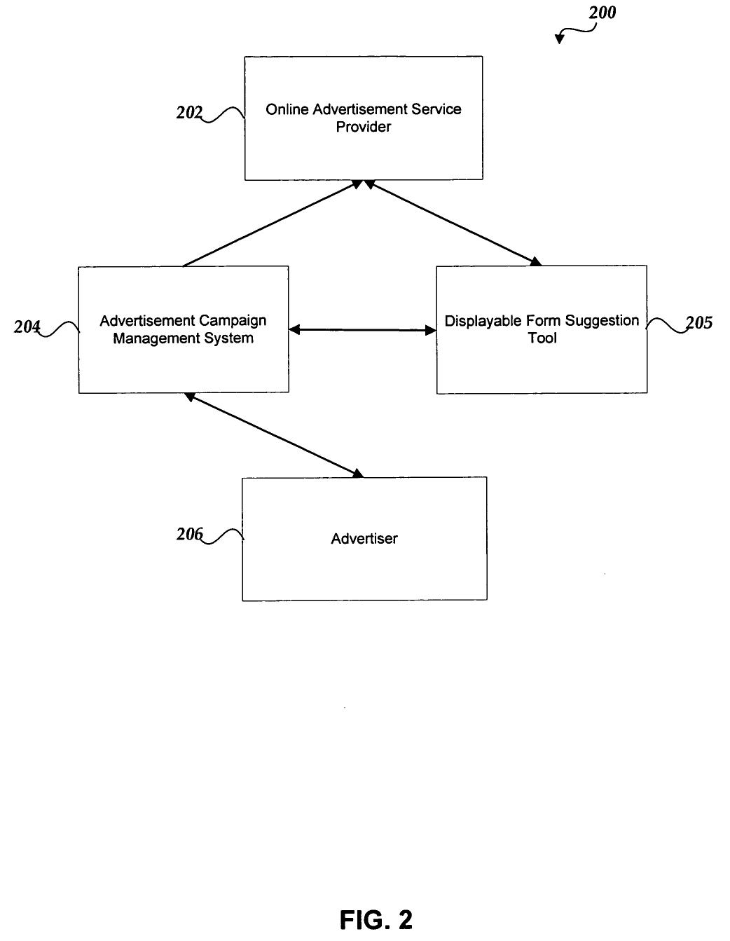

FIG. 2 is a block diagram of one embodiment of a system for predicting a displayable form of a term for insertion into an ad. The system 200 generally includes an online advertisement service provider (“ad provider”) 202 including an ad campaign management system 204 and a displayable form suggestion tool 205, and one or more advertiser systems 206. Typically, the advertiser systems 206 communicate with the ad campaign management system 204 over external networks such as the Internet, and the ad campaign management system 204 and displayable form suggestion tool 205, of the ad provider 202 communicate within the ad provider 202 over internal or external networks. The ad provider 202, ad campaign management system 204, displayable form suggestion tool 205, and advertiser systems 206 may be implemented as software code running in conjunction with a processor such as a personal computer, a single server, a plurality of servers, or any other type of computing device known in the art.

Generally, the displayable form suggestion tool 205 of the ad provider 202 creates one or more models based on search logs of the ad provider 202 to allow the displayable form suggestion tool 205 to predict a set of potential displayable forms of a term received by the ad provider 202. The ad provider 202 may receive the term at the ad campaign management system 204 or the displayable form suggestion tool 205. A displayable form of a term is a form of a term that the ad provider 202 may insert into an ad so that the ad is grammatically correct. A surface form, as discussed in more detail below, is a raw form of a term received by the ad provider 202 from a search engine, a website provider, an editor interacting with the displayable form suggestion tool 205, or from other systems within the ad provider 202 such as the ad campaign management system 204.

After creating the models, when the ad provider 202 receives a term, the displayable form suggestion tool 205 predicts a set of potential displayable forms of the term using the models and suggests the set of potential displayable forms of the term to an editor of the ad provider 202 reviewing the content of digital ads. The displayable form suggestion tool 205 receives a selection of one of the set of potential displayable forms from the editor and may export the selected displayable form of the term to a system of the ad provider 202 for use in an ad. Additionally, the displayable form suggestion tool 205 may modify the one or more models based on the received selection so that the displayable form suggestion tool 205 may more accurately predict displayable forms of received terms in the future as explained in more detail below.

The displayable form suggestion tool 205 creates one or more models to enable the displayable form suggestion tool 205 to predict a set of potential displayable forms for a received term and to determine whether a selected displayable form of a term requires a modifier. As known to those skilled in the art, such as those skilled in statistical analysis, the displayable form suggestion tool 205 may fit a model to a set of data, resulting in a equation that fits a line to the set of data, plus a specific set of numbers to make the line better fit the set of data. In one implementation, the displayable form suggestion tool 205 creates two distinct models, each of which may be stored in the same memory module or different memory modules. However in other implementations, the displayable form suggestion tool 205 may create one model, or more than two models.

In one embodiment, the displayable form suggestion tool 205 creates a displayable form model to utilize in predicting potential displayable forms of terms based on search logs of the ad provider 202. Search logs typically record search terms or bidded phrases, also known as keywords, (collectively “terms”) received by the ad provider 202 from a search engine or a website provider, and ads such as graphical banner ads or sponsored search ads that the ad provider 202 serves in response to the received terms.

Typically, when an ad provider 202 receives a term with an ad request, the ad provider 202 canonicalizes the term and serves one or more ads based on the canonicalized term. Canonicalizing terms allows the ad provider 202 to serve the same ads in response to different surface forms of a term so that an advertiser does not have to bid on every potential combination of words that comprise a term. For example, an ad provider 202 may wish to serve the same ads in response to the different terms “wedding band celtic men,” “celtic wedding band men's,” “mens celtic wedding bands,” “celtic wedding bands for men,” and “man wedding band celtic.” In order to serve the same ads for each of the above-listed illustrative terms, the ad provider 202 establishes a relationship between the terms. One way to establish a relationship between the terms is to follow a method that rephrases each of the terms into the same term, such as the process described below for canonicalizing the terms to map to the same canonicalized term.

One example of a method for canonicalizing terms is the Overture Canonicalizer used by Overture Services, Inc. and Yahoo! Inc., but any canonicalizer could be used. Generally, the ad provider 202 may perform a series of actions so that various surface forms of a term are rephrased into the same canonicalized term. Examples of actions that the ad provider 202 may perform to canonicalize terms include ordering the words within a term in alphabetical order, removing any non-alphanumeric characters from a term, stemming the term (removing pluralization), and removing common words from a term such as “the,” “and,” or any other common term desired by the ad provider 202.

Continuing with the illustrative terms above, to canonicalize the term “celtic wedding band men's,” the ad provider 202 may reorder “celtic wedding band men's” to “band celtic men's wedding.” The ad provider 202 may then remove non-alphanumeric characters from the term so that “band celtic men's wedding” becomes “band celtic mens wedding.” Further, the ad provider 202 may stem “band celtic mens wedding” so that the term becomes “band celtic man wedding.” It will be appreciated that following this same procedure, each of the illustrative terms above will result in a canonicalized form of the term of “band celtic man wedding.” Due to the fact all of the illustrative terms result in a canonicalized form of the term of “band celtic mens wedding,” the ad provider 202 may serve the same ads for each of the different surface forms of the term.

The displayable form suggestion tool 205 reviews the search logs to map one or more different surface forms that were received for a given term to a canonicalized form of the term. In one embodiment, the displayable form suggestion tool 205 may map the top five surface forms of the term that appear in the search logs to a canonicalized form of the term, but the displayable form suggestion tool 205 may map any number of surface forms of a term appearing in the search logs to the canonicalized form of the term. For example, continuing with the illustrative example above, the displayable form suggestion tool 205 may map the terms “wedding band celtic men,” “celtic wedding band men's,” “mens celtic wedding bands,” “celtic wedding bands for men,” and “man wedding band celtic” to the canonicalized form “band celtic man wedding.” In addition to mapping one or more surface forms of each term that appears in the search logs to the canonicalized form of the term, the displayable form suggestion tool 205 may record the number of time each surface form of the term appears in the search logs.

In addition to creating the displayable form model based on the surface forms of a term and its associated canonicalized term, and the number of times each surface form of a term appears in the search logs, the displayable form suggestion tool 205 may examine properties of each surface form of a term to determine if the surface form is more likely to be a displayable form of the term than another surface form. For example, the displayable form suggestion tool 205 may examine properties such as whether a surface form of a term contains a word with an apostrophe, a verb, or non-standard punctuation; whether a surface form of a term is pluralized or ends in a period; and string similarity metrics. Each of the above-listed properties typically occur in surface forms of a term that are more likely to be a displayable form of a term than surface forms of the term that do not exhibit the above-listed properties.

The displayable form suggestion tool 205 creates a modifier model for use in determining whether a displayable form of a term requires a modifier such as the words “products” or “items.” As explained in more detail below, after applying the displayable form model to a term to determine a set of potential displayable forms of the term, one or more of the set of potential displayable forms of the term may require a modifier before insertion into an ad. For example, if after applying the displayable form model to a term, a potential displayable form of the term is “John Smith,” the ad provider 202 does not insert the potential displayable form of the term directly into an ad due to the fact the ad may read “Buy John Smith at XYZ.com.” To address this problem, the ad provider 202 inserts a modifier such as the word “items” into the ad so that the ad may read “Buy John Smith Items at XYZ.com.” In one implementation, the displayable form suggestion tool 205 determines whether a displayable form of a term requires a modifier by examining whether the displayable form of the term is plural. If the displayable form of the term is determined to not be a plural, the displayable form is marked as requiring a modifier. However, the displayable form suggestion tool 205 may use properties of the displayable form of the term other than whether the displayable form of the term is plural to determine whether the displayable form of the term requires a modifier.

In one implementation, if the displayable form suggestion tool 205 determines the displayable able form of the term requires a modifier, an editor manually reviews the displayable form of the term and inserts a modifier. However in other implementations, the displayable form suggestion tool 205 may algorithmically determine a modifier for the displayable form of the term based on data such as search logs.

After the displayable form suggestion tool 205 creates the one or more models for predicting displayable forms of terms and determining whether a displayable form of a term requires a modifier before insertion into an ad, the displayable form suggestion tool 205 may suggest displayable forms of terms for received terms.

The advertiser 206 interacts with the ad campaign management system 204 to create ads such as graphical banner ads and sponsored search listings. It will be appreciated that the advertiser 206 may bid on one or more terms and have the ad campaign management system 204 automatically create ads based on the bidded terms. As described above, advertisers 206 may bid on terms in a form that may not be directly inserted into ads. Therefore, before inserting a bidded term into an ad, an editor of the ad provider 202 must interact with the displayable form suggestion tool 205 to select and approve a displayable form of the bidded term.

During operation, the displayable form suggestion tool 205 receives one or more bidded terms. While the displayable form suggestion tool 205 may receive and process multiple bidded terms at one time, the process below is described with respect to one received bidded term. The displayable form suggestion tool 205 canonicalizes the received bidded term and applies the displayable form model to the canonicalized form of the received bidded term to determine a set of potential displayable forms of the terms. The canonicalized term is matched to the canonicalized term in the displayable form model that maps to one or more surface forms of the term that were found in the search logs. The displayable form suggestion tool 205 determines a set of potential displayable forms of the term based on factors such as a number of times one or more of the surface forms appear in the search logs; whether a surface form of a term contains a word with an apostrophe, a verb, or non-standard punctuation; whether a surface form of a term is pluralized or ends in a period; string similarity metrics, or any other property the displayable form suggestion tool 205 determines is a reliable indication that a surface form of a term is a displayable form of a term.

The displayable form suggestion tool 205 suggests the set of potential displayable forms of the received term to the editor. In one implementation, the displayable form suggestion tool 206 suggests the top five potential displayable forms of the received term to the editor, but the displayable form suggestion tool 206 may suggest any number of potential displayable forms of the received term to the editor.

The displayable form suggestion tool 205 receives a selection from the editor of a displayable form of the received term from the set of proposed displayable forms of the term. After receiving the selection, the displayable form suggestion tool 205 applies the modifier model to determine whether the selected displayable form requires a modifier. As discussed above, in one implementation, by applying the modifier model, the displayable form suggestion tool 205 determines whether the selected displayable form of the term requires a modifier based on whether the displayable form is in a plural form. If the displayable form of the term is a plural, a modifier is not necessary. If the displayable form of the term is not a plural, a modifier is necessary.

Additionally, the displayable form suggestion tool 205 may adjust the displayable form model based on the received displayable form selection. For example, in one embodiment, the displayable form suggestion tool 205 may suggest a top five potential displayable forms for a received term. If the third suggested displayable form of the term is selected rather than the first suggested displayable form of the term, the displayable form suggestion tool 205 may weight the selected displayable form of the term over the first suggested displayable form of the term in the displayable form model so that in the future, the displayable form suggestion tool 205 suggests the selected displayable form of the term over the first suggested form of the term.

In addition to adjusting the displayable form model based on received displayable form selections, the displayable form suggestion tool 205 may apply supervised machine learning algorithms or function learning algorithms to adjust the ranking of potential displayable forms of terms relating to a canonicalized form of the term. The displayable form suggestion tool 205 may apply supervised machine learning algorithms or function learning algorithms to predict an appropriate displayable form of the surface forms of a term found in the search logs. Generally, the displayable form suggestion tool 205 may begin using supervised machine learning algorithms or function learning algorithms to further develop the displayable form model at any point after minimal associations have been established between canonicalized terms and an appropriate displayable form of the terms in the displayable form model. However, the more developed the displayable form model is before the displayable form suggestion tool 205 begins using supervised machine learning algorithms and function learning algorithms, the more accurate the supervised machine learning algorithms and function learning algorithms will be in predicting an appropriate displayable form for a canonicalized form of a term.

In one embodiment, the machine learning algorithm or function learning algorithm learns a function based on properties such as whether a surface form of a search term contains a word with an apostrophe, a verb, or non-standard punctuation; whether a surface form of a search term is pluralized or ends in a period; string similarity metrics or any other property the displayable form suggest tool 205 determines is indicative of a reliable relationship between displayable forms of a term and a surface forms of the term.

Below is an illustrative example for predicting a displayable form of a term. Table A illustrates information that may appear in a displayable form model.

TABLE A
Information Regarding Men's Shoes Terms

| Term | Occurrence in Logs | Canonicalized Term |
|---|---|---|
| mens shoe | 13883 | man shoe |
| men's shoes | 10926 | man shoe |
| men shoes | 3339 | man shoe |
| shoes for men | 594 | man shoe |
| man shoes | 413 | man shoe |

The displayable form suggestion tool 205 receives the term “shoes for man.” As described above, the displayable form suggestion tool 205 canonicalizes the term “shoes for man” to “man shoe.” Applying the displayable form model, the displayable form suggestion tool 205 matches the canonicalized term and determines the top five displayable forms of the term are mens shoe, men's shoes, men shoes, shoes for men, and man shoes. The top five displayable forms of the term are suggested to an editor.

Even though the top surface form of the term is “mens shoe” based on the number of occurrences in the search logs, the displayable form suggestion tool 205 receives a selection of the second surface form, “men's shoes,” due to the fact the second surface form would be grammatically correct when inserted into an ad such as a graphical banner ad or a sponsored search listing.

The displayable form suggestion tool 205 applies the modifier model to the selected displayable form of the term to determine if a modifier is necessary before inserting the displayable form into an ad. The displayable form suggestion tool 205 determines that due to the fact the term “men's shoes” is plural, it is not necessary to add a modifier to the selected displayable form of the term.

After receiving the selected displayable form of the term, the displayable form suggestion tool 205 may adjust the ranking of potential surface forms associated with the canonicalized term man shoe so that in the future, the surface form “men's shoes” is suggested to an editor before the surface form “mens shoe.”

Further, the displayable form suggestion tool 205 may apply a supervised machine learning algorithms of function learning algorithms to the adjusted displayable form model. By applying a supervised machine learning algorithms or function learning algorithms to the adjusted displayable form model, the displayable form suggestion tool 205 may determine that based on selections of displayable forms such as the selection of “men's shoes,” an apostrophe in a surface form of a term is indicative of a reliable relationship between a displayable form of a term and a surface form of the term. Based on this determined relationship, the supervised machine learning algorithms or function learning algorithms may predict in other terms that a second ranked surface term containing an apostrophe is more likely to be a displayable form of a term than a first ranked surface term without an apostrophe.

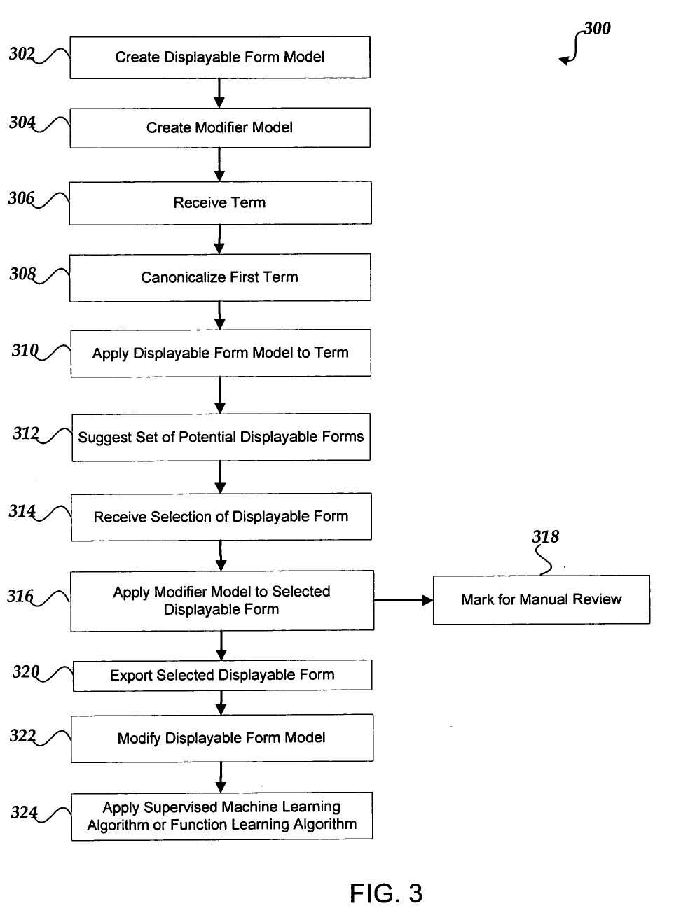

FIG. 3 is a flow chart of one embodiment of a method for predicting a displayable form of a term. The method 300 begins with a displayable form suggestion tool creating a displayable form model for predicting a displayable form of a term based on search logs at step 302. As discussed above, the displayable form suggestion tool creates the model by mapping surface forms of terms that appear in the search logs to the canonicalized forms of the terms. Further, the displayable form suggestion tool records the number of times one or more surface forms of the terms appear in the search logs and any properties of the surface forms that the displayable form suggestion tool has determined evidence a reliable indication that a surface form of a term is a displayable form of the term. The displayable form suggestion tool creates a modifier model for determining whether a selected displayable form of a term requires a modifier before insertion into an ad at step 304. As described above, the displayable form model and modifier model may be two distinct models, one model, or expanded over more than two models.

The displayable form suggestion tool receives a term at step 306 and canonicalizes the received term into a canonicalized term at step 308. As described above, to canonicalize the term, the displayable form suggestion tool may perform actions such as ordering the words within a term in alphabetical order, removing any non-alphanumeric characters from a term, stemming the term (removing pluralization), and removing common words from a term.

After canonicalizing the received term, the displayable form suggestion tool applies the displayable form model to the received term at step 310 to determine a set of potential displayable forms of the term. As described above, the displayable form suggestion tool examines the displayable form model to determine potential display forms of the received term based on at least the number of times one or more surface forms of the term appear in the search logs. The displayable form suggestion tool suggests a set of potential displayable forms of the term to an editor at step 312.

The displayable form suggestion tool receives a selected displayable form of the term of the set of potential displayable forms of the term at step 314. The displayable form suggestion tool applies the modifier model at step 316 to determine whether the selected displayable form of the term requires a modifier. As discussed above, in one implementation, the displayable form suggestion tool may determine whether the selected displayable form of the term requires a modifier based on whether the selected displayable form of the term is in a plural form. If the displayable form suggestion tool determines that a modifier is necessary, the displayable form suggestion tool may mark the selected displayable form of the term for manual review by an editor at step 318. However, if the displayable form suggestion tool determines a modifier is not necessary, the displayable form suggestion tool may export the selected displayable form of the term to anther system of the ad provider at step 320.

At step 322, the displayable form suggestion tool may modify the displayable form model based on the received selected displayable form of the term. For example, if the selected displayable form of the term was not the first suggested potential displayable term, as described above, the displayable form model may be adjusted so that the selected displayable form of the term is suggested before any other potential displayable form of the term.

Additionally, the displayable form selection tool suggestion tool may apply a supervised machine learning algorithms or function learning algorithms to the adjusted displayable form model at step 324. As described above, the supervised machine learning algorithms or function learning algorithms adjust the displayable form model so that the displayable form model may more accurately predict displayable forms of terms based on relationships between previously selected displayable forms of terms and their associates surface forms.

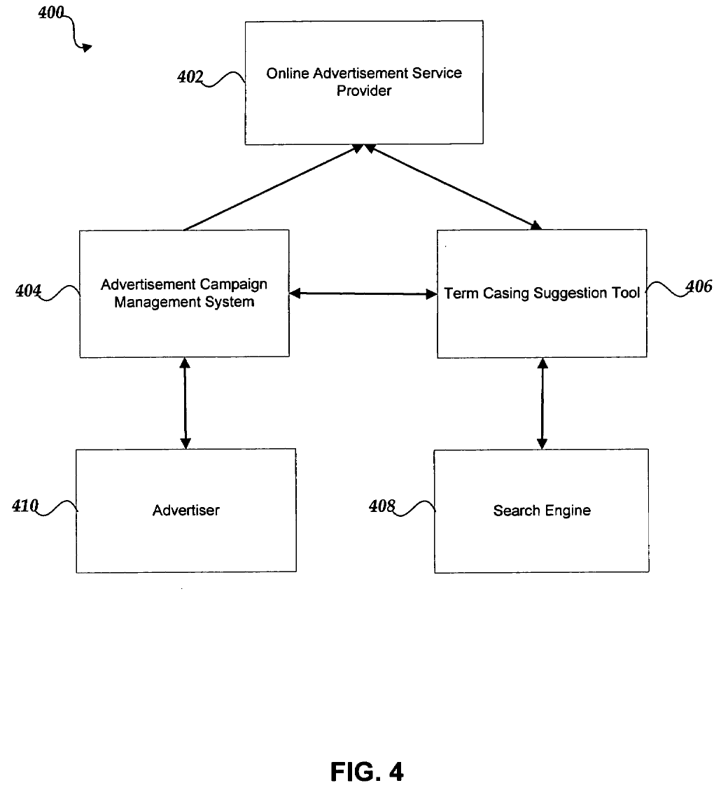

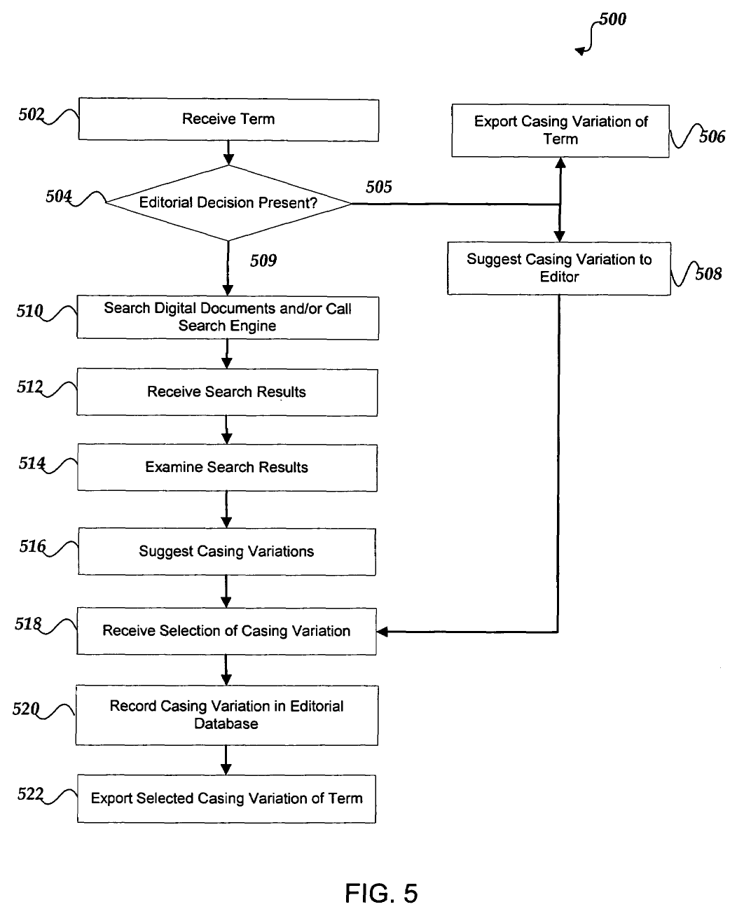

While the disclosed systems and methods of FIGS. 2 and 3 may be used to determine a proper displayable form of a term for uses such as insertion into an ad, the display form may need to be modified to ensure correct capitalization of the display form of the term and to ensure that appropriate symbols are inserted into the displayable form of the term. One system and method for predicting a proper casing of a term are described below with respect to FIGS. 4 and 5.

FIG. 4 is a block diagram of a system for determining a proper casing of a term. Generally, the system 400 includes an ad provider 402 including an ad campaign management system 404 and a term casing suggestion tool 406, a search engine 408, and one or more advertiser systems 410. The advertiser systems 410 typically communicate with the ad campaign management system 404 over an external network such as the Internet, and the ad provider 402, ad campaign management system 404, term casing suggestion tool 406, and search engine 408 may communicate with one another over internal or external networks. The ad provider 402, ad campaign management system 404, term casing suggestion tool 406, search engine 408, and advertiser systems 410 may be implemented as software code running in conjunction with a processor such as a personal computer, a single server, a plurality of servers, or any other type of computing device known in the art.

In one embodiment, the term casing suggestion tool 406 is utilized to determine a proper casing for a term to be inserted into an ad such as a graphical banner ad or a sponsored search listing. A proper casing of a term may include whether one or more letters in the term should be upper case or lower case, and whether missing symbols should be inserted with the term such as !, *, $, or #.

Generally, the term casing suggestion tool 406 receives a term and determines whether an editor has previously established a proper casing for the term. If an editor has previously established a proper casing for the term, the term casing suggestion tool 406 may automatically export the proper casing of the term to systems within the ad provider 402 such as the ad campaign management system 404, or the term casing suggestion tool 406 may display the proper casing of the term to an editor. If the term casing suggestion tool 404 determines an editor has not previously established a proper casing for the term, the term casing suggestion tool 406 utilizes digital documents such as digital dictionaries or digital sources of information such as that provided by Whereonearch Ltd. to search for the term. Additionally, the term casing suggestion tool 406 may call the search engine 408 to search the Internet for the term. In some implementations, the term casing suggestion tool 406 first searches digital documents such as digital dictionaries for the term before using the search engine 408 to search for the term on the Internet due to the fact digital dictionaries may be more reliable sources of information than the Internet.

The term casing suggestion tool 406 examines the resulting search results based on the digital documents and/or the Internet, and may record each casing variance of the term in the search results and a number of times each casing variance occurs in the search results. The term casing suggestion tool 406 suggests at least a set of potential casing variances of the term to an editor based on the number of times each casing variance occurs in the search results. The term casing suggestion tool 406 receives a selection from the editor of one of the set of potential variances of the term. In response to the selection from the editor, the term casing suggestion tool 406 may record the selection for future use and export the selected casing variation of the term to systems within the ad provider 402 such as the ad campaign management system 404.

During operation, the term casing suggestion tool 406 receives one or more terms. Each term may include any number of words and symbols. The term casing suggestion tool 408 may receive terms from an editor interacting with the term casting suggestion tool 406, from advertisers interacting with the ad campaign management system 404, or from other systems within the ad provider 402 such as the displayable form selection tool described above or the ad campaign management system 404. A received term is typically in a surface form that will be inserted into an ad such as a graphical banner ad or a sponsored search listing. However, the casing of the received term may have to be altered for insertion into an ad. For example, the term casing suggestion tool 406 may receive terms such as “rsa securid software,” “RSA securid Software,” “RSA SECURID SOFTWARE,” or “rsa securID software.” (RSA and RSA SecurID are trademarks of RSA Security Inc.) Each casing in the above-listed terms will need to be changed to “RSA securID Software” for insertion into a title of an ad and will need to be changed to “RSA securID software” for insertion into the text of an ad. Similarly, the term casing suggestion tool 306 may receive terms that require the insertion of a symbol. For example, the term casing suggestion tool 306 may receive that term “etrade” that needs to be changed to “E*TRADE” or receive the term “yahoo” that needs to be changed to “Yahoo!”. (E*TRADE is a trademark of E*TRADE Securities, Inc. and Yahoo! Is a trademark of Yahoo! Inc.)

After receiving the term, the term casing suggestion tool 406 checks a database of editorial casing decisions to determine whether an editor has previously determined a proper casing for the received term. The database of editorial casings decisions typically associates received terms and the editorial casing decisions of a correction casing variation for the term.

If the term casing suggestion tool 406 determines the database includes a previous editorial casing decision for the received term, the term casing suggestion tool 406 may perform actions such as export the proper casing of the term to other systems within the ad provider 404 such as the ad campaign management system 406 for insertion into ads or suggest the proper casing of the term to an editor interacting with the term casing suggestion tool 406. However, if the term casing suggestion tool 406 determines the database does not include a previous editorial casing decision, the term casing suggestion tool 406 searches for the term in digital sources such as digital dictionaries or a collection of approved ads stored at the ad provider 402, or calls a search engine 408 to search the Internet for the term.

The term casing suggestion tool 406 examines search results based on the digital sources and/or the Internet relating to the term and records each casing variation of the term in the search results and the number of times each casing variation occurs in the search results. In some implementations, the term casing suggestion tool 406 may automatically export the casing variation of the term that occurred the most number of times in the search results. However, in other implementations, the term casing suggestion tool may suggest one or more potential casing variations to an editor based on the number of times each casing variation occurs in the search results. It will be appreciated that the term casing suggestion tool 406 may suggest only the casing variation that occurred the most number of times in the search results, or the term casing suggestion tool 406 may suggest any set of terms such as the top five casing variations that occurred the most number of times in the search results.

If the term casing suggestion tool 406 suggests one or more potential casing variations to an editor, the editor selects a proper casing variation of term by interacting the term casing suggestion tool 406. The term casing suggestion tool 406 may export the selected casing variation of the term to other systems of the ad provider 403 such as the ad campaign management system 404 for insertion into titles and descriptions of ads such as graphical banner ads or sponsored search listings. Additionally, the term casing suggestion tool 406 may record the proper casing variation in the database of editorial casing decisions for use when the term casing suggestion tool 406 receives the same term in the future. In some implementations, the term casing suggestion tool 406 may record the proper casing variation in the database of editorial casing decisions after only one editor has determined a proper casing variation for the term. However in other implementations, the term casing suggestion tool 406 will record the proper casing variation in the database of editorial casing decisions after multiple editors have determined the same proper casing variation for the term.

FIG. 5 is a flow chart of one embodiment of a system for determining a proper casing of a term. While the method of FIG. 5 is described with respect to a single received term, it will be appreciated that a term casing suggestion tool may process any number of terms at one time. The method 500 begins with a term casing suggestion tool receiving a term at step 502. The term casing suggestion tool determines whether a database of editorial decisions includes a previous decision of an editor of the proper casing variation of the term at step 504.

If the database of editor decisions includes a previous casing decision regarding the term (505), the proper casing of the term may be automatically exported at step 506 to another system of the ad provider such as an ad campaign management system. Alternatively, the term casing suggestion tool may suggest the proper casing of the term to an editor for approval at step 508.

If the database of editorial decisions does not include a previous casing decision regarding the term (509), the term casing suggestion tool may search digital sources such as digital dictionaries for the term or call a search engine to search the Internet for the term at step 510. The term casing suggestion tool receives the search results based on the digital sources and/or the Internet at step 512 and examines the search results at step 514 to record each casing variation of the term in the search results and the number of times each casing variation of the term occurs in the search results.

The term casing suggestion tool suggests one or more casing variations to an editor at step 516 based on the number of times each casing variation of the term appears in the search results. The term casing suggestion tool receives a selection of one of the suggested casing variations at step 518. The term casing suggestion tool records the selected casing variation for the term in the database of editor decision at step 520 and exports the proper casing of the term at step 522 to systems in the ad provider such as an ad campaign management system for insertion into ads such as graphical banner ads or sponsored search listings.

FIGS. 1-5 disclose systems and methods for predicting a displayable form of a term and systems and methods for predicting a correct casing variation of a term. It will be appreciated that the disclosed tools provide editors efficient tools for rephrasing terms and determining a correct casing variation of terms before performing actions such as inserting terms into ads.

While the disclosed systems and methods have been explained in the context of determining a proper displayable form of a term and a correct casing variation of a term for insertion into ads, it will be appreciated that the disclosed systems and methods may be used with other systems of an online advertisement service provider. For example, the displayable form suggestion tool may be used to determine the relevance of an ad. After a displayable form of a term is determined, a landing page for the ad may be searched for the displayable form of the term. If the displayable form of the term appears on the landing page of the ad, the advertisement is likely relevant. However, if the displayable form of the term does not appear on the landing page of the ad, the advertisement is likely not relevant.

Similarly, the term casing suggestion tool may be used to determine important portions of a search query. For example, if a search engine and/or online advertisement service provider receives the query “john smith products,” the search engine and/or online advertisement service provider may determine that since “john smith” should be capitalized, it is therefore an important part of the search query and cannot be removed from the search query without changing the meaning of the search query.

It is therefore intended that the foregoing detailed description be regarded as illustrative rather than limiting, and that it be understood that it is the following claims, including all equivalents, that are intended to define the spirit and scope of this invention.

1. A method for predicting a displayable form of a term, the method comprising:
receiving a term;
canonicalizing the term;
applying a displayable form model to the term to determine a set of potential displayable forms of the term;
suggesting the set of potential displayable forms of the term; and
receiving a selection of one of the displayable forms of the term of the set of potential displayable forms of the term.

2. The method of claim 1, further comprising:
exporting the selected displayable form of the term to a system of an online advertisement service provider.

3. The method of claim 2, wherein the system of the online advertisement service provider is an advertisement campaign management system.

4. The method of claim 1, wherein canonicalizing the term comprises:
removing non-alpha-numeric characters from the term;
removing stop-words from the term;
stemming the term; and
placing words that comprise the term in alphabetical order.

5. The method of claim 1, further comprising:
applying a modifier model to the selected displayable form of the term to determine whether the selected displayable term requires a modifier.

6. The method of claim 5, wherein applying the modifier model to the selected displayable form of the term determines whether the selected displayable form of the term requires a modifier based on whether the selected displayable form of the term is plural.

7. The method of claim 1, further comprising:
adjusting a portion of the displayable form model relating to the term based on the selected displayable form of the term.

8. The method of claim 1, further comprising:
applying a function learning algorithm to the displayable form model to adjust a portion of the displayable form model not relating to the term based on the selected displayable form of the term.

9. The method of claim 1, further comprising:
building the displayable form model based on terms appearing in one or more search logs of an online advertisement service provider.

10. The method of claim 9, wherein the displayable form model comprises associating a plurality of terms received by the online advertisement service provider and a canonicalized form of the plurality of terms.

11. A computer-readable storage medium comprising a set of instructions for predicting a displayable form of a term, the set of instructions to direct a processor to perform acts of:
receiving a term;
canonicalizing the term;
applying a displayable form model based on search logs of an online advertisement service provider to the term to determine a set of potential displayable forms of the term;
suggesting the set of potential displayable forms of the term to an editor;
receiving a selection of one of the displayable forms of the term of the set of potential displayable forms of the term from the editor; and
exporting the selected displayable form of the term to a system of the online advertisement service provider.

12. The computer-readable storage medium of claim 11, wherein the system is an advertisement campaign management system.

13. The computer-readable storage medium of claim 11, further comprising a set of instructions to direct the processor to perform acts of:
applying a function learning algorithm to the displayable form model to adjust at least a portion of the displayable form model not relating to the term based on the selected displayable form of the term.

14. A system for predicting a displayable form of a term comprising:
a memory storing a displayable form model based on search logs of an online advertisement service provider, the displayable form model associating a plurality of terms received by the online advertisement service provider and a canonicalized form of the plurality of terms;
a displayable form suggestion tool operative to receive a term, to apply the displayable form model to the received term to determine a set of potential displayable forms of the term, to suggest the set of potential displayable terms, and to receive a selection of one of the displayable forms of the terms of the set of potential displayable forms of the term.

15. The system of claim 14, wherein the displayable form suggestion tool is further operative to export the selected displayable form of the term to a system of the online advertisement service provider.

16. The system of claim 15, wherein the displayable form suggestion tool is operative to export the selected displayable form of the term to an advertisement campaign management system of the online advertisement service provider.

17. The system of claim 14, wherein:
the memory further stores a modifier model comprising information indicating when a displayable form of a term requires a modifier for insertion into an online advertisement; and
the displayable form suggestion tool is further operative to apply the modifier model to the selected displayable form of the term to determine whether a modifier is required to insert the selected displayable form of the term into an online advertisement.

18. The system of claim 17, wherein the online advertisement is a graphical banner advertisement.

19. The system of claim 17, wherein the online advertisement is a sponsored search advertisement.

20. The system of claim 14, wherein the displayable form suggestion tool is further operative to apply a function learning algorithm to the displayable form model to adjust at least a portion of the displayable form model not relating to the term based on the selected displayable form of the term.
